(19) United States
(12) Patent Application Publication
(10) Pub. No.: US 2011/0013392 A1
(43) Pub. Date: Jan. 20, 2011

(54) LIGHTING APPARATUS

(76) Inventor: William D. Little, JR., Corinth, TX (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/752,105

(22) Filed: Mar. 31, 2010

Related U.S. Application Data
(60) Provisional application No. 61/225,712, filed on Jul. 15, 2009.

(51) Int. Cl. F21S 4/00; F21V 29/00

(52) U.S. Cl. 362/235; 362/373

(57) ABSTRACT

A lighting apparatus includes a heat dissipation module and a light-emitting diode (LED) module. The heat dissipation module comprises heat sinks assembling each other, and each heat sink comprises air channels formed therein for air convection. The LED module is mounted on at least one of the heat sinks

### CROSS-REFERENCE TO RELATED APPLICATION

This application claims the priority benefit of U.S. provisional application Ser. No. 61/225,712, filed on Jul. 15, 2009. The entirety of the above-mentioned patent application is hereby incorporated by reference herein and made a part of this specification.

### BACKGROUND OF THE INVENTION

1. Field of the Invention

The present invention generally relates to a lighting apparatus, and in particular, to a lighting apparatus having more efficient heat dissipation.

2. Description of Related Art

A light-emitting diode (LED) is a semiconductor device that is fabricated by using a compound of chemical elements selected from the groups III-V, such as GaP, GaAs, and so forth. This kind of semiconductor material has the property of converting electrical energy into light. More specifically, electrons and holes in the semiconductor material are combined to release excessive energy in the form of light when a current is applied to the semiconductor material. Hence, an LED can emit light.

As the light generated by an LED is a form of cold luminescence instead of thermal luminescence or electric discharge luminescence, the lifespan of LED devices is up to one hundred thousand hours. Furthermore, LED devices do not require idling time. LED devices have the advantage of fast response speed (about 10⁻⁹ seconds), compact size, low power consumption, low pollution (mercury-free), high reliability, and the capability for mass production. Hence, the applications of LED devices are fairly extensive. For example, LEDs can be used in large-sized display boards, traffic lights, cell phones, scanners, light sources for fax machines, and so forth.

In recent years, as the brightness and light-emitting efficiency of LEDs are being improved and the mass production of white light LEDs is carried out successfully, white light LEDs are increasingly used in illumination devices, such as indoor and outdoor illuminators. Generally speaking, high-power LEDs all encounter a heat dissipation problem. When an LED is operated at an overly high temperature, the brightness of the LED lamp may be reduced and the lifespan of the LED may be shortened. For these reasons, how to design a proper heat dissipation system for LED lamps has become a focus of researchers and designers in this field.

### SUMMARY OF THE INVENTION

The invention provides a lighting apparatus having more efficient heat dissipation.

The invention provides a lighting apparatus including a heat dissipation module and a light-emitting diode (LED) module. The heat dissipation module comprises heat sinks assembling each other, and each heat sink comprises air channels formed therein for air convection. The LED module is mounted on at least one of the heat sinks.

In one embodiment of the invention, a first connection element is assembled to the heat sinks, each heat sink comprises a base having a plurality of openings and heat dissipation fins disposed on the base extending upwardly from the base, and the air channels each existing between any two adjacent heat dissipation fins communicate with the openings.

In one embodiment of the invention, an interval exists between any two adjacent heat dissipation fins.

In one embodiment of the invention, a width of the interval between any two adjacent heat dissipation fins from closer to the base towards farther from the base is not a constant.

In one embodiment of the invention, the width of the interval farther from the base is larger than that of the interval closer to the base.

In one embodiment of the invention, the first connection element has a pair of first sliding connection portions extended alongside two opposite sidewalls of the first connection element, the base of the heat sink has a second sliding connection portion extended alongside one sidewall of the base, and the second sliding connection portion is engaging with one of the first sliding connection portions so as to make the heat sink slide relatively to the first connection element.

In one embodiment of the invention, each first sliding connection portion is a sliding rail, and the second sliding connection portion is a sliding groove.

In one embodiment of the invention, each first sliding connection portion is a sliding groove, and the second sliding connection portion is a sliding rail.

In one embodiment of the invention, the heat dissipation module further includes a second connection element disposed above the first connection element and having a pair of third sliding connection portions extended alongside two opposite sidewalls of the second connection element. One of the heat dissipation fins of each heat sink that is closer to the first connection element further includes a fourth sliding connection portion. The fourth sliding connection portion engages with one of the third sliding connection portions so as to make each heat sink slide relatively to the second connection element.

In one embodiment of the invention, the heat sinks, the first connection element and the second connection element form a first containing space.

In one embodiment of the invention, the lighting apparatus further includes a power supply slidingly disposed in the first containing space and located between the first connection element and the second connection element.

In one embodiment of the invention, the lighting apparatus further includes a supporting element disposed on the second connection element and having an accommodating opening at one side of the supporting element.

In one embodiment of the invention, each third sliding connection portion is a sliding rail, and the fourth sliding connection portion is a sliding hook.

In one embodiment of the invention, each third sliding connection portion is a sliding hook, and the fourth sliding connection portion is a sliding rail.

In one embodiment of the invention, the first connection element has a first surface, the base of the heat sink has a second surface, and the second lower surface of the base and the first lower surface of the first connection element are substantially aligned to each other.

In one embodiment of the invention, the openings of the base are arranged in array.

In one embodiment of the invention, the heat dissipation fins extend upwardly from the base and bend toward a space above the first connection element.

In one embodiment of the invention, the heat dissipation fins extend upwardly from the base and bend toward a space far from above the first connection element.

In one embodiment of the invention, the second lower surface of the base has a recess, and each LED module is disposed in the recess of the base.

In one embodiment of the invention, the LED module comprises a plurality of LED arrays and a plurality of lenses. Each LED arrays includes a carrier and a plurality of light-emitting diodes disposed on the carrier and electrically connected to the carrier. The lenses respectively cover the corresponding LED arrays.

In one embodiment of the invention, each lens comprises a flat portion and a protrusion portion, the flat portion has a rough surface surrounding the protruding portion.

In one embodiment of the invention, the lighting apparatus further includes a protecting cover having a plurality of sliding hooks at the sides of the protecting cover. One of the heat dissipation fins of each heat sink farther from the first connection element includes a sliding rail. The sliding hooks respectively lock the sliding rails so as to make the protecting cover slide relatively to the heat dissipation module.

In one embodiment of the invention, the protecting cover has a main plate and a side plate disposed around and connecting to the main plate. The main plate, the side plate and the heat dissipation fins of the heat sinks form a second containing space. The side plate has a plurality of gas circulation holes.

In one embodiment of the invention, the lighting apparatus further includes two side covers respectively overlaying two ends of the heat dissipation module.

In one embodiment of the invention, the lighting apparatus further includes two side sealing slices respectively located between the side covers and the ends of the heat dissipation module.

In one embodiment of the invention, the lighting apparatus further includes a plurality of fasteners. The side covers respectively have a plurality of first fastening holes and the side sealing slices respectively have a plurality of second fastening holes. The second fastening holes are respectively corresponding to the first fastening holes. The fasteners are suitable to go through the first fastening holes and the second fastening holes to fasten the side covers on the heat dissipation module.

The invention further provides a lighting apparatus including a light-emitting diode (LED) module being assembled on a heat sink. The heat sink includes a base having a first surface for the LED module being mounted thereon and having a plurality of openings making a plurality of air channels that communicate with intervals between each of a plurality of heat dissipation fins extending upwardly from the base.

In one embodiment of the invention, the width of the interval between each two adjacent heat dissipation fins that is farther from the base is larger than the interval that is closer to the base.

The invention further provides a lighting apparatus including a heat sink and a light-emitting diode (LED) module. The heat sink has a base and fins disposed on the base extending toward a direction, and an air channel each formed between any two adjacent fins. The LED module is disposed on the base.

As described above, the lighting apparatus of the invention has the heat dissipation fins extending upwardly from the base, and an air channel exists between any two adjacent heat dissipation fins and communicates with the openings of the base. Consequently, the heat generated by the LED module disposed on the lower surface of the base can be dissipated by thermal-conduction and thermal-convection. As a result, the heat dissipation efficiency of the lighting apparatus is improved.

In order to the make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view of a lighting apparatus according to one embodiment of the invention.

FIG. 2A is a schematic exploded view of the lighting apparatus in FIG. 1.

FIG. 2B is a partially enlarged view of the heat sink of the lighting apparatus in FIG. 2A.

FIG. 2C is a partially enlarged view of the first connection element of the lighting apparatus in FIG. 2A.

FIG. 2D is a schematic perspective view of the heat dissipation module of the lighting apparatus in FIG. 2A.

FIG. 3 is a schematic exploded view of a lighting apparatus according to another embodiment of the invention.

FIG. 4 is an image figure of the heat dissipation module according to a further embodiment of the invention.

FIG. 5 is an image figure of a lighting apparatus according to a further embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

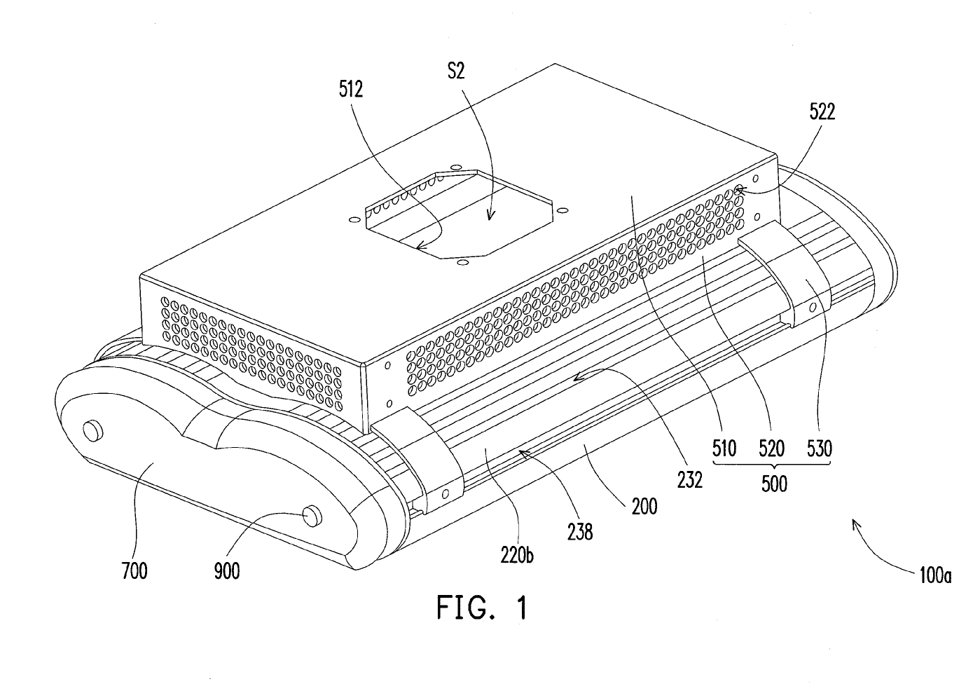

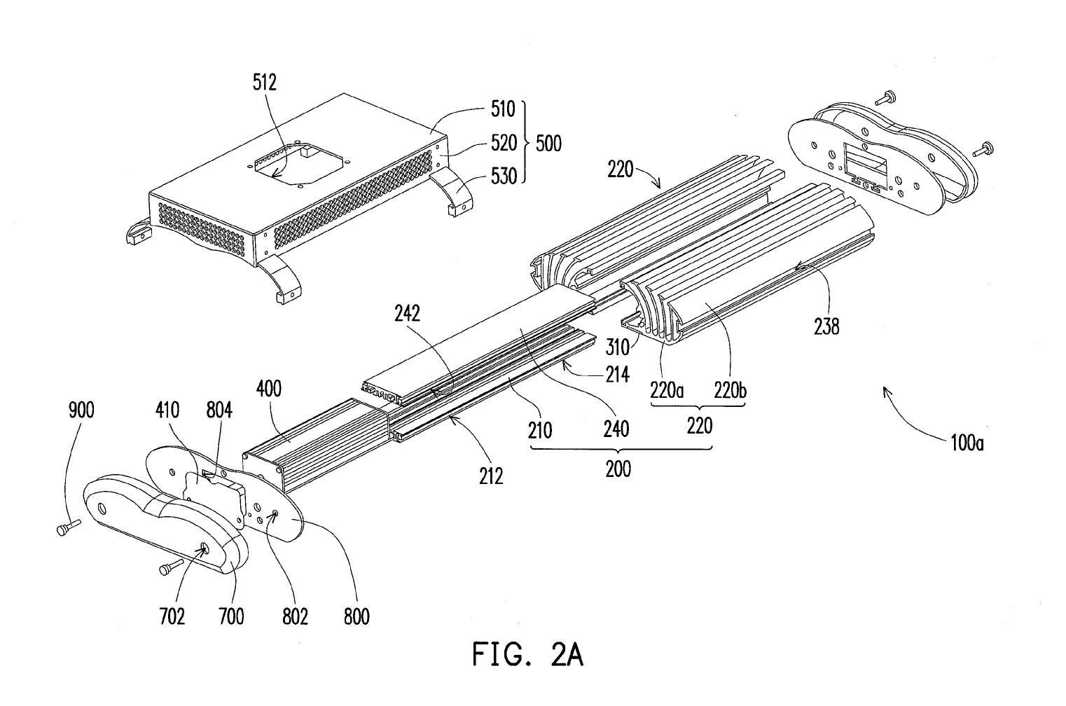

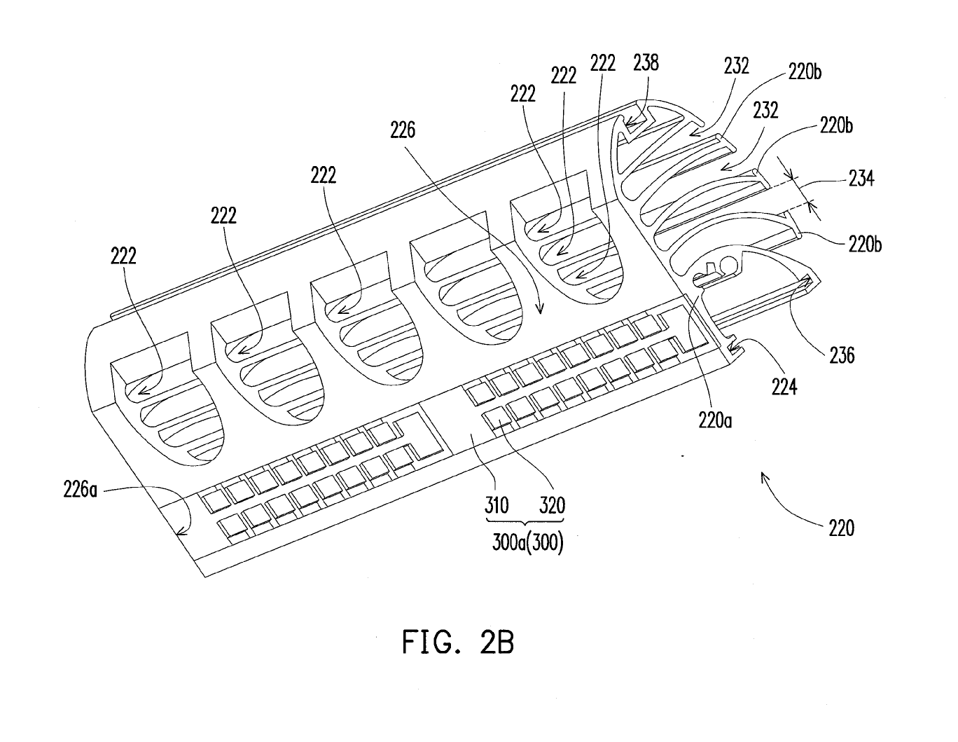

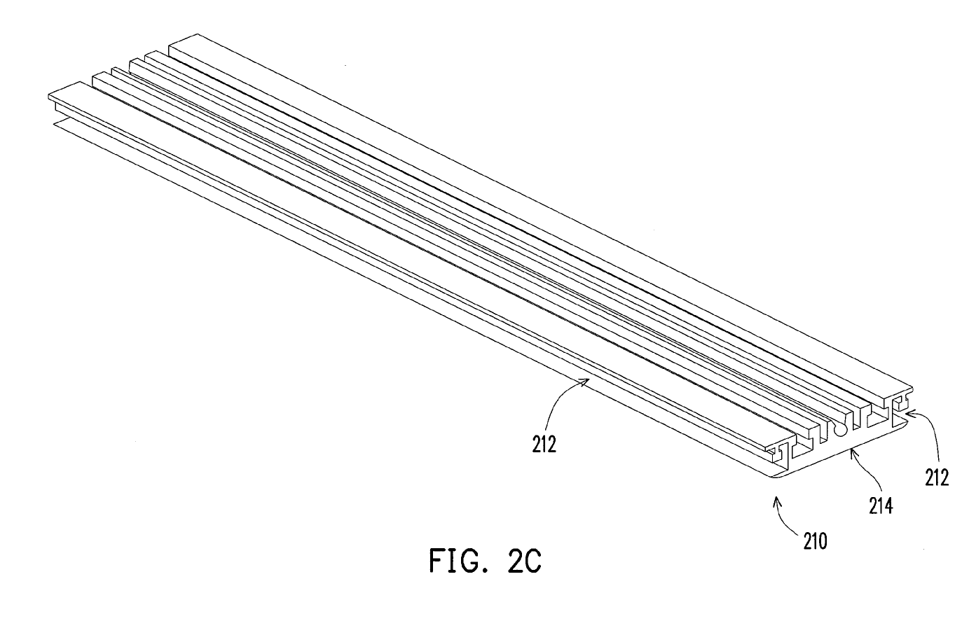

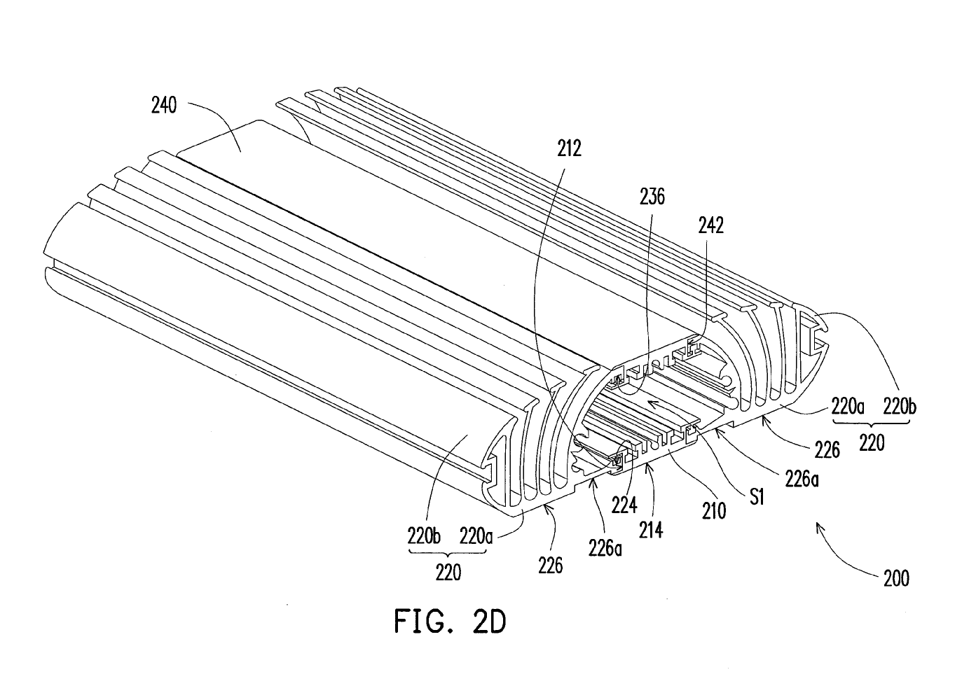

FIG. 1 is a schematic perspective view of a lighting apparatus according to one embodiment of the invention; FIG. 2A is a schematic exploded view of the lighting apparatus in FIG. 1; FIG. 2B is a partially enlarged view of the heat sink of the lighting apparatus in FIG. 2A; FIG. 2C is a partially enlarged view of the first connection element of the lighting apparatus in FIG. 2A; FIG. 2D is a schematic perspective view of the heat dissipation module of the lighting apparatus in FIG. 2A. Referring to FIG. 1 and FIG. 2B at first, in this embodiment, a lighting apparatus 100a including a heat dissipation module 200 and a light-emitting diode (LED) module 300 is provided.

To be more specific, with reference to FIG. 2A, FIG. 2B, FIG. 2C and FIG. 2D, the heat dissipation module 200 includes a first connection element 210 and two heat sinks 220. The first connection element 210 and the heat sink 220 of the heat dissipation module 200 are not formed in one piece, and a material of the heat dissipation module 200 is aluminium, for instance. The first connection element 210 has a pair of first sliding connection portions 212 extended alongside two opposite sidewalls of the first connection element 210 and a first lower surface 214 of the first connection element 210. The heat sinks 220 are slidingly disposed at the opposite sidewalls of the first connection element 210. According to this embodiment, each heat sink 220 includes a base 220a and a plurality of heat dissipation fins 220b. The heat dissipation fins 220b of the present embodiment is integrally formed with the corresponding base 220a and extend upwardly from the corresponding base 220a. However, in other embodiments, the heat dissipation fines 220b and the corresponding base 220a may be independent components and connected with each other. The base 220a has a plurality of openings 222, a second sliding connection portion 224 extended alongside one sidewall of the base 220a and a second lower surface 226 of the base 220a. Herein, the openings 222 are arranged in array, and the openings 222 are exposed a portion of the heat dissipation fins 220b.

The second sliding connection portion 224 of the corresponding base 220a engages with the first sliding connection portions 212 of the first connection element 210 so as to make each heat sink 220 slide relative to the first connection element 212 and assembled with the first connection element 212. The second lower surface 226 of the corresponding base 220a and the first lower surface 214 of the first connection element 210 are substantially aligned to each other.

It should be noted that the present invention does not limit the implementation structure of the first connection element 210 and the heat sinks 220, although the first connection element 210 herein is implemented by having the first sliding connection portions 212 and the heat sinks 240 herein is implemented by having the second sliding connection portions 224, and the second sliding connection portions 224 are engaging with the first sliding connection portions 212 so as to make the heat sinks 240 slide relatively to the first connection element 210. Any known structure able to have the same fixing effect still falls in the technical scheme adopted by the present invention without departing from the scope of the invention. In other words, in other unshown embodiments, anyone skilled in the art can select in their wills the above-mentioned structure according to the application need so as to reach the required technical effect.

The LED module 300 includes a plurality of LED arrays 300a and a plurality of lenses (not shown) is mounted on the second lower surfaces 226 of the corresponding bases 220a of the corresponding heat sinks 220, as shown in FIG. 2B. In this embodiment, each LED array 300a comprises a carrier 310 and a plurality of light-emitting diodes 320 disposed on the carrier 310 and electrically connected to the carrier 310. The lenses respectively cover the corresponding LED arrays 310b. It notes that the each lens having a flat portion and a protrusion portion, the flat portion has a rough surface (not shown) surrounding the LEDs 320 so that the lateral light emitted from the LEDs of each LED array 310a is uniformly diffused through the rough surface. In addition, with reference to FIGS. 2B and 2C, the second lower surfaces 226 of the corresponding bases 220a respectively have a recess 226a, and the LED arrays 300a are respectively disposed in the recess 226a.

Particularly, an air channel 232 exists between any two adjacent heat dissipation fins 220b and communicates with the openings 222. Furthermore, according to this embodiment, referring to the FIG. 2B, an interval 234 exists between any two adjacent heat dissipation fins 220b, and a width of the interval 234 between any two adjacent heat dissipation fins 220b from closer to the corresponding bases 220a towards farther from the corresponding bases 220a is not a constant. For example, preferably, the width of the interval 234 farther from the corresponding bases 220a is larger than that of the interval closer to the corresponding bases 220a, so that the thermal-convection of the air can be accelerated to dissipate the heat generated by the LED module 300 located at the second lower surfaces 226 of the bases 220a. In addition, the air channels 232 are quite long so that the efficiency of the thermal convection can be elevated due to the “stack effect”. Since the air channel 232 exists between any two adjacent heat dissipation fins 220b and communicates with the openings 222 of the base 220a, the heat generated by the LED module 300 is firstly transmitted to the base 220a of the heat sinks 220 and then quickly transferred to the heat dissipation fins 220b for dissipation into the ambient air. The air inside the air channel 232 is heated by the heat dissipation fins 220b and being discharged to the outside through the air channel 232. At this time, outside cool ambient air is entered into the air channel 232 through the openings 222. Therefore, the heat from the LED module 300 is dissipated by natural convection through opening 222 and the air channel 232. The heat generated from the LED module 300 is dissipated by thermal-conduction and thermal-convection. As a result, the heat dissipation efficiency of the lighting apparatus 100a is improved.

Note that the first sliding connection portions 212 of the first connection element 210 are sliding rails and the second sliding connection portions 224 of the corresponding heat sinks 220 are sliding grooves according to the present embodiment. However, the present embodiment does not limit the types of the first sliding connection portions 212 and the second sliding connection portions 224. In another embodiment, the first sliding connection portions 212 may be sliding grooves and the second sliding connection portions 224 may be sliding rails, which still belong to a technical choice adoptable in the present embodiment and fall within the protection scope of the present embodiment. In addition to the above embodiments, the present invention may be embodied in other fashions, as long as the first sliding connection portions 212 are respectively engaged with the second sliding connection portions 224, the applications and variations of which should be known to those of ordinary skill in the art and is thus not described herein.

Referring to FIG. 2A and FIG. 2D, in this embodiment, the heat dissipation module 200 further includes a second connection element 240 disposed above the first connection element 210 and having a pair of third sliding connection portions 242 extended alongside two opposite sidewalls of the second connection element 240. In one embodiment, the structure of the second connection element 240 and the structure of the first connection element 210 are substantially the same in structure. In addition, one of the heat dissipation fins 220b of each heat sink 220 closer to the second first connection element 240 further includes a fourth sliding connection portion 236. The fourth sliding connection portion 236 engages with one of the third sliding connection portions 242 so as to make each heat sink 220 slide relative to the second connection element 240 and assemble with the second connection element 240.

Note that the third sliding connection portions 242 of the second connection element 240 are sliding rails and the fourth sliding connection portions 236 of the corresponding heat sinks 220 are sliding hooks according to the present embodiment. However, the present embodiment does not limit the types of the third sliding connection portions 242 and the fourth sliding connection portions 236. In another embodiment, the third sliding connection portions 242 may be sliding hooks and the fourth sliding connection portions 236 may be sliding rails, which still belong to a technical choice adoptable in the present embodiment and fall within the protection scope of the present embodiment. In addition to the above embodiments, the present invention may be embodied in other fashions, as long as the third sliding connection portions 242 are respectively engaged with the fourth sliding connection portions 236, the applications and variations of which should be known to those of ordinary skill in the art and is thus not described herein.

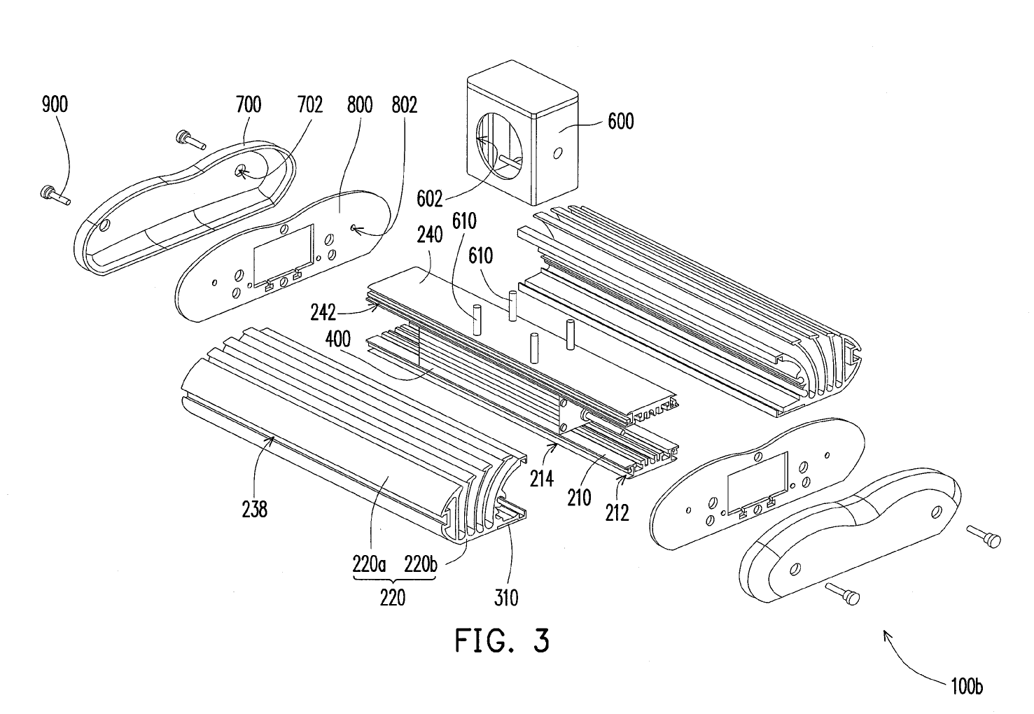

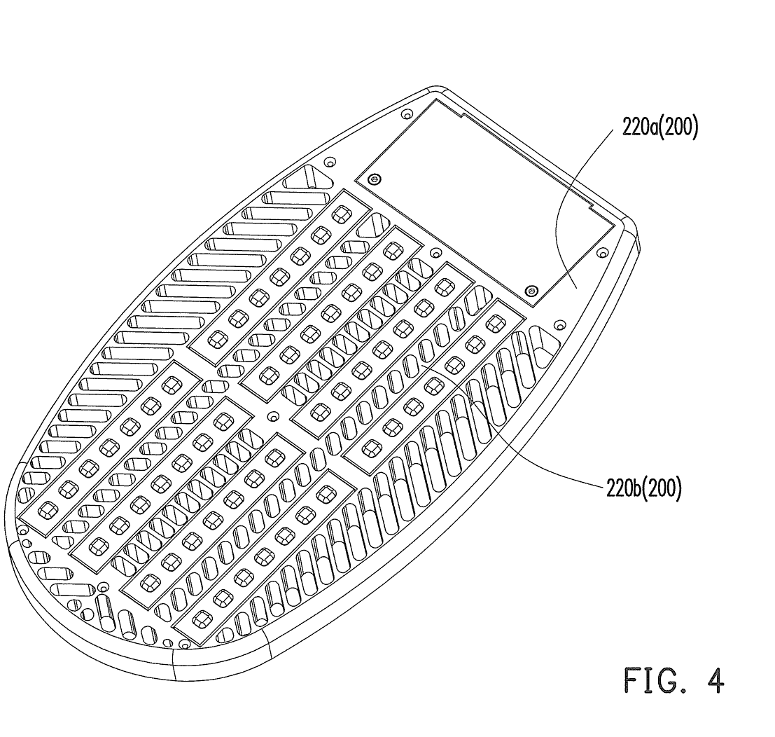

It is noted that, in this embodiment, with reference to FIG. 2B and FIG. 2D, the heat dissipation fins 220b of the heat sinks 220 extend upwardly from the corresponding base 220a and bend toward a space above the first connection element 210. Moreover, the heat sinks 220, the first connection element 210 and the second connection element 220 form a first containing space S1. The lighting apparatus 100a of the present embodiment further includes a power supply 400 slidingly disposed in the first containing space S1 and located between the first connection element 210 and the second connection element 240, as shown in FIG. 3, for supplying power to drive the lighting apparatus 100a. However, in other embodiment, the heat dissipation fins 220b can also extend upwardly from the base 220a and bend toward a space far from above the first connection element 210 or just extend upwardly form the base 220a. Furthermore, the present embodiment does not limit the types of the heat dissipation fins 220b, although the heat dissipation fins 220b of the heat sinks 220 are substantially symmetry. In addition to the above embodiments, the heat sink 220 of the present invention may be embodied in other fashions. As shown in FIG. 4, the heat sink 200 includes a base 220a and the heat dissipation fins 220b. The heat dissipation fins 220b are disposed on the base 220a, and the heat dissipation fins 220b of the present embodiment may integrally formed with the corresponding base 220a. an air channel exists between any two adjacent heat dissipation fins 220b. The difference between this embodiment and others is that the heat dissipation fins 220b extended toward a direction may extend horizontally from the base 220a.

Furthermore, referring to FIG. 1 and FIG. 2A, in this embodiment, the lighting apparatus 100a further includes a protecting cover 500 having a plurality of sliding hooks 530 at the sides of the protecting cover 500. Herein, the protecting cover 500 can avoid the dust falling into the heat dissipation module 200 and has a main plate 510 and a side plate 520 disposed around the main plate 510 and connected to the main plate 510. To be more specific, one of the heat dissipation fins 220b of each heat sink 220 farthest from the first connection element 210 includes a sliding rail 238, and the sliding hooks 530 respectively lock the sliding rails 238 so as to make the protecting cover 500 slide relative to the heat dissipation module 200.

Particularly, the main plate 510, the side plate 520 and the heat dissipation fins 220b of the heat sinks 220 form a second containing space S2. The main plate 510 of the protecting cover 500 has an opening 512, and the side plate 520 of the protecting cover 500 has a plurality of gas circulation holes 522. The heat generated by the LED module 300 can be dissipated from the openings 222 of the base 220a to the outside environment sequentially through the air channels 232, the gas circulation holes 522 and the opening 512. Since the heat generated by the LED module 300 is dissipated by thermal-conduction and thermal-convection, the heat of the LED modules 300 is discharged and the heat dissipation efficiency of the lighting apparatus 100a is advanced.

Moreover, the lighting apparatus 100a in the present embodiment further includes two side covers 700, two side sealing slices 800 and a plurality of fasteners 900, as shown in FIG. 1 and FIG. 2A. The side covers 700 respectively overlay two ends of the heat dissipation module 200, wherein the side covers 700 respectively have a plurality of first fastening holes 702. The side sealing slices 800 are respectively located between the side covers 700 and the ends of the heat dissipation module 200. The side sealing slices 800 respectively have a plurality of second fastening holes 802 respectively corresponding to the first fastening holes 702. The fasteners 900 are suitable to go through the first fastening holes 702 and the second fastening holes 802 to fasten the side covers 700 on the heat dissipation module 200. As a result, the lighting apparatus 100a has a compact structure and is better at preventing dust falling into the heat dissipation module 200. In addition, the fasteners 900 include screws or bolts, for instance. In addition, one of the side sealing slices 800 has an opening 804 respectively, and the power supply 400 can be slidingly disposed in the first containing space S1 by a additional bracket 410 passing through the opening 804 of the corresponding sealing slices 800.

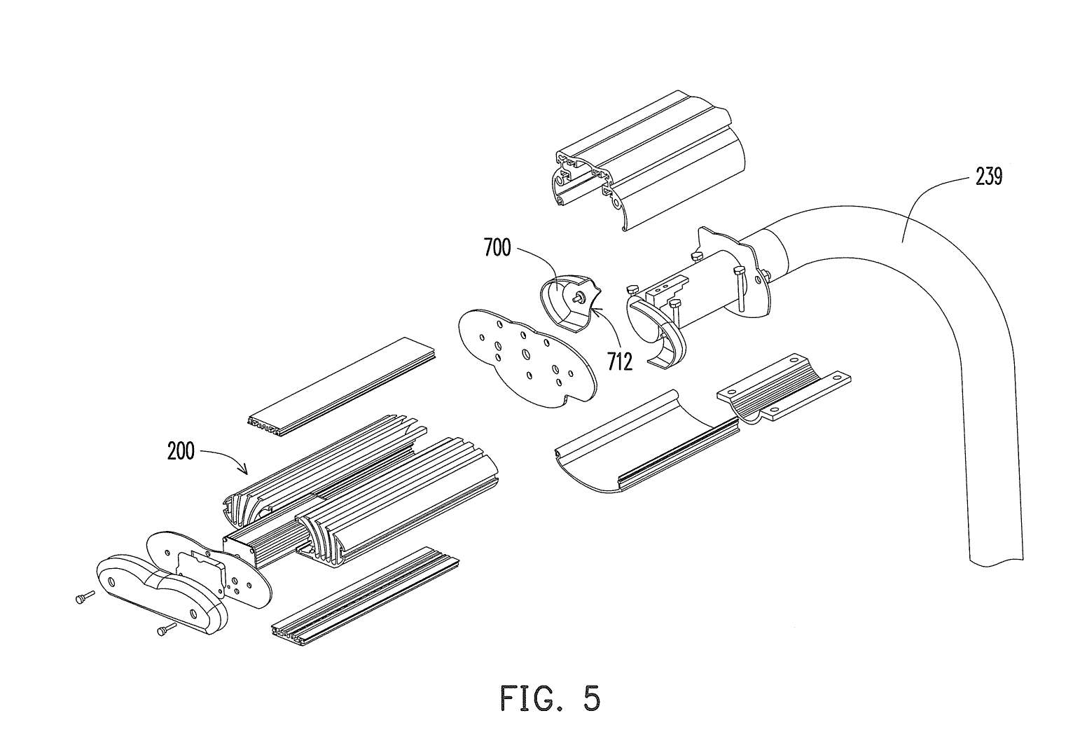

FIG. 3 is a schematic exploded view of a lighting apparatus according to another embodiment of the invention. Referring to FIG. 3, the element having the same numbers or names of the lighting apparatus 100a in FIG. 2A have identical functions and working principles. The difference between the lighting apparatus 100b of this embodiment and that of the above-mentioned embodiment is that lighting apparatus 100b does not include the protecting cover 500. The lighting apparatus 100b in the present embodiment further includes a supporting element 600 and a plurality of additional rods 610, wherein the supporting element 600 is disposed on the second connection element 240 and has an accommodating opening 602 for containing an object, such as a fixing element, as not shown. The additional rods 610 are disposed on the second connection element 240 for supporting and fixing the supporting element. Note that the opening 512, 602 are not limited to form on the protective cover 520 or supporting element 600. As shown in FIG. 5, an opening 712 may be formed on the side cover 700 for containing an object, such as a shaft 239.

Based on the above, the lighting apparatus of the invention has heat dissipation fins extending upwardly from the base, and an air channel exists between any two adjacent heat dissipation fins which communicates with the openings of the base. Consequently, the heat generated by the LED module disposed on the lower surface of the base can be dissipated by thermal-conduction and thermal-convection. Furthermore, since the interval between any two adjacent heat dissipation fins from closer to the base towards farther from the base is not a constant, the thermal-convection of the air can be accelerated to dissipate the heat generated by the LED module. As a result, the heat dissipation efficiency of the lighting apparatus is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall.

What is claimed is:

1. A lighting apparatus, comprising:
a heat dissipation module, comprising heat sinks assembling each other, each heat sink comprising air channels formed therein for air convection; and
a light-emitting diode (LED) module mounted on at least one of the heat sinks.

2. The lighting apparatus as claimed in claim 1, further comprising a first connection element assembling to the heat sinks, wherein each heat sink comprises a base having a plurality of openings and heat dissipation fins disposed on the base extending upwardly from the base, and the air channels each existing between any two adjacent heat dissipation fins communicate with the openings.

3. The lighting apparatus as claimed in claim 2, wherein an interval exists between any two adjacent heat dissipation fins.

4. The lighting apparatus as claimed in claim 3, wherein a width of the interval between any two adjacent heat dissipation fins from closer to the base towards farther from the base is not a constant.

5. The lighting apparatus as claimed in claim 4, wherein the width of the interval farther from the base is larger than that of the interval closer to the base.

6. The lighting apparatus as claimed in claim 2, wherein the first connection element has a pair of first sliding connection portions extended alongside two opposite sidewalls of the first connection element, the base of the heat sink has a second sliding connection portion extended alongside one sidewall of the base, and the second sliding connection portion is engaging with one of the first sliding connection portions so as to make the heat sink slide relatively to the first connection element.

7. The lighting apparatus as claimed in claim 6, wherein each first sliding connection portion is a sliding rail, and the second sliding connection portion is a sliding groove.

8. The lighting apparatus as claimed in claim 6, wherein each first sliding connection portion is a sliding groove, and the second sliding connection portion is a sliding rail.

9. The lighting apparatus as claimed in claim 6, wherein heat dissipation module further comprises a second connection element disposed above the first connection element and having a pair of third sliding connection portions extended alongside two opposite sidewalls of the second connection element, and one of the heat dissipation fins of each heat sink closer to the first connection element further comprises a fourth sliding connection portion, the fourth sliding connection portion engages with one of the third sliding connection portions so as to make each heat sink slide relatively to the second connection element.

10. The lighting apparatus as claimed in claim 9, wherein the heat sinks, the first connection element and the second connection element form a first containing space.

11. The lighting apparatus as claimed in claim 10, further comprising a power supply slidingly disposed in the first containing space and located between the first connection element and the second connection element.

12. The lighting apparatus as claimed in claim 9, further comprising a supporting element disposed on the second connection element and having an accommodating opening at one side of the supporting element.

13. The lighting apparatus as claimed in claim 9, wherein each third sliding connection portion is a sliding rail, and the fourth sliding connection portion is a sliding hook.

14. The lighting apparatus as claimed in claim 9, wherein each third sliding connection portion is a sliding hook, and the fourth sliding connection portion is a sliding rail.

15. The lighting apparatus as claimed in claim 2, wherein the first connection element has a first surface, the base of the heat sink has a second surface, and the second lower surface of the base and the first lower surface of the first connection element are substantially aligned to each other.

16. The lighting apparatus as claimed in claim 2, wherein the openings of the base are arranged in array.

17. The lighting apparatus as claimed in claim 2, wherein the heat dissipation fins extend upwardly from the base and bend toward a space above the first connection element.

18. The lighting apparatus as claimed in claim 2, wherein the heat dissipation fins extend upwardly from the base and bend toward a space far from above the first connection element.

19. The lighting apparatus as claimed in claim 2, wherein the second lower surface of each base has a recess, and the LED module is disposed in the recess of the base.

20. The lighting apparatus as claimed in claim 2, further comprising a sliding rail disposed on the outer sidewall of the one of the heat dissipation fins of each heat sink farthest from the first connection element.

21. The lighting apparatus as claimed in claim 2, further comprising a protecting cover having a plurality of sliding hooks at the sides of the protecting cover, wherein one of the heat dissipation fins of each heat sink farther from the first connection element comprises a sliding rail, and the sliding hooks respectively lock the sliding rails so as to make the protecting cover slide relatively to the heat dissipation module.

22. The lighting apparatus as claimed in claim 21, wherein the protecting cover has a main plate and a side plate disposed around and connecting to the main plate, the main plate, the side plate and the heat dissipation fins of the heat sinks form a second containing space, and the side plate has a plurality of gas circulation holes.

23. The lighting apparatus as claimed in claim 2, further comprising two side covers respectively overlaying two ends of the heat dissipation module.

24. The lighting apparatus as claimed in claim 23, further comprising two side sealing slices respectively located between the side covers and the ends of the heat dissipation module.

25. The lighting apparatus as claimed in claim 24, further comprising a plurality of fasteners, wherein the side covers respectively have a plurality of first fastening holes and the side sealing slices respectively have a plurality of second fastening holes, the second fastening holes are respectively corresponding to the first fastening holes, the fasteners are suitable to go through the first fastening holes and the second fastening holes to fasten the side covers on the heat dissipation module.

26. The lighting apparatus as claimed in claim 1, wherein the LED module comprises:
a plurality of LED arrays, wherein each LED arrays comprises:
a carrier; and
a plurality of light-emitting diodes, disposed on the carrier and electrically connected to the carrier; and
a plurality of lenses respectively covering the corresponding LED arrays.

27. The lighting apparatus as claimed in claim 26, wherein each lens comprises a flat portion and a protruding portion, the flat portion has a rough surface surrounding the protruding portion.

28. A lighting apparatus, comprising a light-emitting diode (LED) module being assembled on a heat sink, where the heat sink comprises:
a base, having a first surface for the LED module being mounted thereon and having a plurality of openings making a plurality of air channels that communicate with intervals between each of a plurality of heat dissipation fins extending upwardly from the base.

29. The lighting apparatus as claimed in claim 28, wherein the width of the interval between each two adjacent heat dissipation fins that is farther from the base is larger than the interval that is closer to the base.

30. A lighting apparatus, comprising:
a heat sink having a base, and fins disposed on the base extending toward a direction and air channels each formed between any two adjacent fins; and
a light-emitting diode (LED) module disposed on the base.
